(19) United States
(12) Patent Application Publication
(10) Pub. No.: US 2005/0210170 A1
(43) Pub. Date: Sep. 22, 2005

(54) Measuring apparatus with plural modules

(75) Inventor: Takuya Otani, Tokyo (JP)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: Agilent Technologies, Inc.

(21) Appl. No.: 11/076,739

(22) Filed: Mar. 10, 2005

(30) Foreign Application Priority Data
Mar. 18, 2004 (JP) 2004-079036

(51) Int. Cl. G06F 13/12

(52) U.S. Cl. 710/71

(57) ABSTRACT

A measuring apparatus comprising plural modules having parallel-serial converters; a controller having plural serial-parallel converters and plural FIFO memories; and serial buses connecting each of the modules and each of the parallel-serial converters.

### FIELD OF THE INVENTION

The present invention pertains to a measuring apparatus having a serial transmission system, and in particular, to a measuring apparatus for data transfer between plural modules and a controller by a serial transmission system.

### DISCUSSION OF THE BACKGROUND ART

A large number of signals under test are input and the measurement data are integrated and analyzed with measuring apparatuses that measure many properties of LSIs, TFT arrays, and other semiconductor devices; therefore, the architecture of the measuring apparatus is often one that is divided into modules for analog measurement, analog-digital conversion (ADC) of the measurement values, and a controller part for data processing and analysis of the digital data obtained from the modules such as the technology cited in JP Kokai [unexamined] 2001-52,281.

A typical measuring apparatus having architecture divided into modules 230, 231 and 232, and a controller 220 is shown in FIG. 2. Of the lines showing connection between structural elements in the figures, the solid lines (263, 264, and 265) show data lines and the double lines (250 and 251) show parallel buses. Signals from a semiconductor device, a TFT array, or other measurement subject 210 may input to each module 230, 231, and 232. Each module 230, 231, and 232 is connected to a memory 221 in the controller 220 via the parallel bus 251. Moreover, an arbiter 200 is also connected to the parallel bus 251. The controller 220 has the memory 221 and a processor 222, and the memory 221 and the processor 222 are connected by the parallel bus 250.

Next, the operation of the measuring apparatus in FIG. 2 is described. First, when analog signals are input from the measurement subject 210 to modules 230, 231, and 232, analog-digital conversion (ADC) is performed by modules 230, 231, and 232. The converted digital data is transferred to the controller 220 via the data bus 251. In this case, when plural modules may simultaneously output data to the parallel bus 251. As a result of the data collision on the parallel bus 251, precise data transfer is impossible.

Therefore, the arbiter 200 must control the timings of the data transfer as shown in FIG. 2 in order to avoid the data collision. The module 230 outputs transfer request signals to the arbiter 200 before the data is transferred. The arbiter 200 that has received the transfer request signals evaluates whether or not the parallel bus is in use. If it is not in use, authorization signals are output to the module 230. The module 230 that has received these authorization signals transfers digital data to the memory 221 on the controller 220 via the parallel bus 251. When the data transfer is completed, the module 230 outputs transfer completion signals to the arbiter 200. The arbiter 200 does not accept the data transfer requests from other modules 231 and 232 until these transfer completion signals are received.

Thus, the data from each module 230, 231, and 232 is transferred in succession to the memory 221. The processor 222 then reads the data from the memory 221 and averages, assesses the degree of correlation, assesses quality, and performs other data processing on the measurement data.

However, when the data is transferred between modules 230, 231 and 232, and the controller 220 via parallel bus 251 as shown in FIG. 2, the data cannot simultaneously be transferred from plural modules, because of sharing the parallel bus using the arbiter to the controller among modules. In general, measuring apparatuses sample signals from the measurement subject 210 by the same timing, but each module must wait for other modules to finish their data transfer before it can perform the data transfer. The total time required completing all measurements increases as the number of modules increases. The use of a parallel bus with a fast data transfer rate has been considered as a countermeasure to this increase in time, but as the data transfer rate of the parallel bus increases, electric data line skew problem is introduced. The effect of the difference in the amount of time that each transmission line is delayed cannot be disregarded when the bus speed is increased. Furthermore, there is a problem with the system in FIG. 2 in that the structure of the measuring apparatus may become more complex because of implementing the arbiter 200.

### SUMMARY OF THE INVENTION

A measuring apparatus comprising plural modules that have a parallel to serial conversion means; a controller having plural serial to parallel conversion means and plural FIFO memories; and serial buses for connecting each of the modules and each of the parallel to serial conversion means. Simultaneous transfer between each module and the controller becomes possible by disposing a serial bus between each module and the controller and performing serial transfer. Even if measurement data are simultaneously transferred to the controller side, the data does not collide on the controller side because FIFO memories have been disposed on the controller side.

The present invention makes it possible to provide a measuring apparatus with a simple device structure and to shorten the time needed until measurement results are obtained.

### BRIEF DESCRIPTION OF THE DRAWINGS

FIG. 1 is a schematic drawing of the measuring apparatus of the working example of the present invention.

FIG. 2 is a schematic drawing of the measuring apparatus of the prior art.

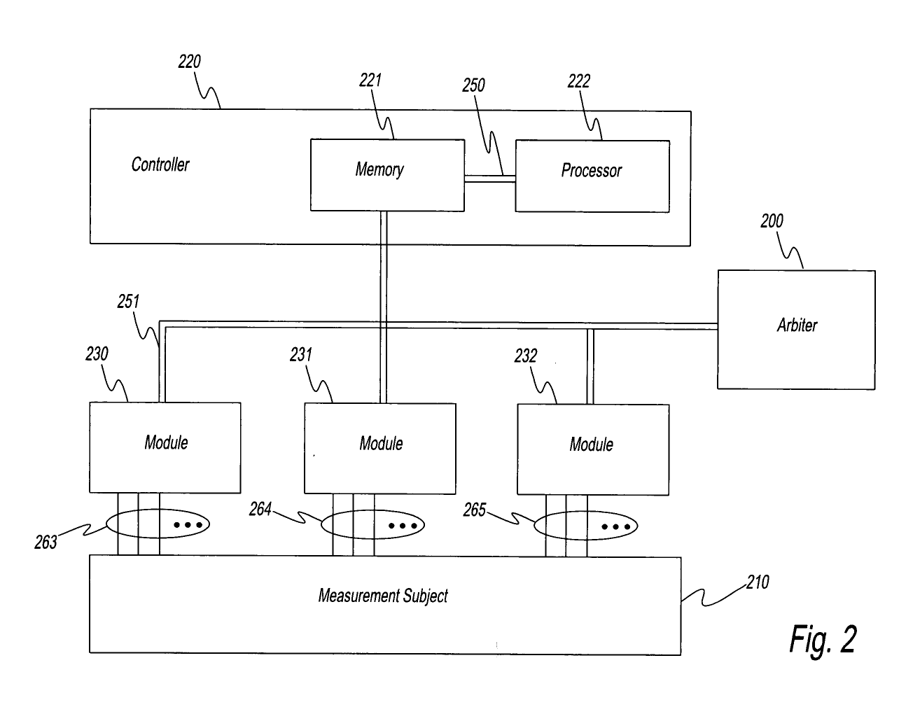

FIG. 3 is a diagram of the clock-embedded conversion system.

### DETAILED DESCRIPTION OF THE PREFERRED EMBODIMENT

A measuring apparatus that is a preferred embodiment of the present invention is described in detail while referring to the drawings. The solid lines in the figures referred to hereafter are data lines (163, 164, 165) or serial buses (160, 161, 162) and the double lines are parallel buses (170, 171, etc.).

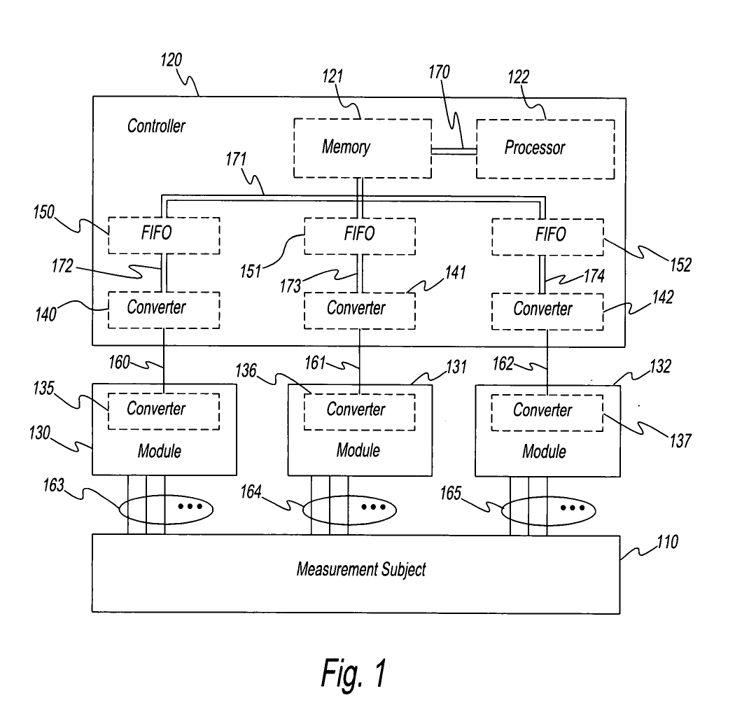

FIG. 1 is a schematic drawing of the measuring apparatus of the present invention. This measuring apparatus comprises three modules 130, 131, and 132 connected to a measurement subject 110 and a controller 120 connected to each module 130, 131, and 132 by serial buses 160, 161, and 162. Modules 130, 131, and 132 house, respectively, ADCs (not illustrated) and converters 135, 136, and 137 that convert parallel signals to serial signals, and the output of each converter 135, 136, and 137 is connected to serial bus 160, 161, and 162, respectively. Moreover, controller 120 comprises the following: converters 140, 141, and 142 for converting serial signals to parallel signals; first-in first-out memories (FIFO memories) 150, 151, and 152 connected to converters 140, 141, and 142 by parallel buses 172, 173, and 174, respectively; a memory 121 connected to each FIFO memory 150, 151, and 152 by parallel bus 171; and a processor 122 connected to memory 121 by parallel bus 170. There are three modules in the present working example, but there can also be two or four or more modules. Moreover, measurement subject 110 can be an ammeter, charge meter, or other such measuring apparatus or a volt probe, piezoelectric element, or other such measurement element connected to an IC chip, TFT array, or other device under test. There may be plural measurement objects as well. Furthermore, it is not necessary to dispose an ADC inside modules 130, 131, and 132 when the measurement signals from measurement subject 110 are digital signals.

The operation of the measuring apparatus in FIG. 1 is described. When analog measurement signals are input from a measurement subject 110 to the modules 130, 131, and 132, the analog measurement signals are converted to parallel signals (digital signals) by the ADCs inside modules 130, 131, and 132. The parallel signals are then converted to serial signals by the parallel to serial converters 135, 136 and 137, and the data is transferred to the controller 120. Serial buses are disposed in between each module 130, 131 and 132, and the controller 120; therefore, the data transfer can be started even when other modules are in the middle of transferring data. By means of this working example, the data transfer is performed by differential signals to increase the reliability of the data transfer, but single-ended signals may also be used when the transmission path is short or when a cable with good transmission properties is used. Serial to parallel converters 140, 141 and 142 of the controller 120 that have received the data from modules 130, 131 and 132 convert serial signals to parallel signals and the data is accumulated in FIFO memories 150, 151 and 152. The accumulated data is read in succession and recorded in a pre-determined format on memory 121. The processor 122 reads the data from the memory 121 to perform averaging, to calculate degree of correlation, to assess quality, and to perform other processing.

Moreover, converters 140, 141 and 142 may also be capable of performing parallel to serial signal conversion, and converters 135, 136, and 137 may be capable of performing serial to parallel conversion. The measuring apparatus is then capable of not only transferring the data from modules 130, 131 and 132 to the controller 120, but also from the controller 120 to modules 130, 131 and 132, such as transferring of a module control program.

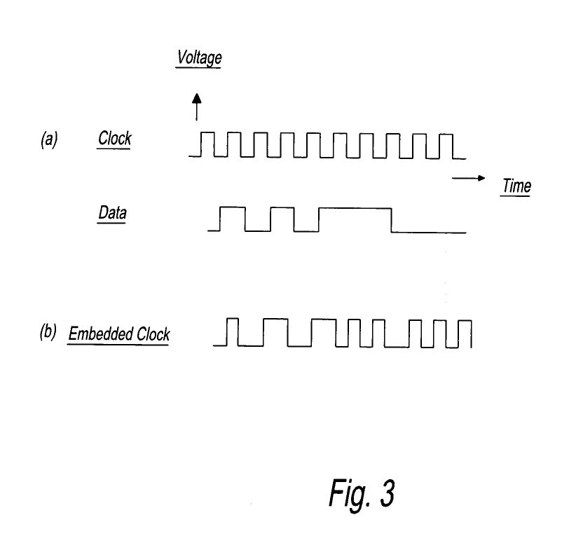

In general, the transferred data themselves and the clock showing the timing of the data transmission are sent during serial data transfer between the controller 120 and modules 130, 131 and 132. For instance, when the data string “1010111000” is transmitted, the clock and data signals are transmitted, as shown in FIG. 3(a). The y-axis in the figure is voltage and the x-axis is time. When the voltage is at high level when the clock edge is present, data value 1 is recognized and when it is at the low level, data value 0 is recognized.

As shown in FIG. 3(a), if a transmission system whereby the clock signals and the data signals are separately transmitted is adopted, the clock signals and the data signals are transmitted through separate transmission paths and a difference in the transmission delay time of the two signals (skew) is produced. This difference in the transmission delay time is not a large problem if the clock frequency is low or the transmission path is short, but it becomes large enough that it cannot be disregarded when the clock frequency is increased in order to increase transmission speed. Moreover, as it is clear from the signal waveform of data signals in FIG. 3(a), when same data values are continued, the data signals retain constant voltage and the frequency of the data signals therefore decreases, while when different data signals are joined together, the frequency of the data signals increases. Therefore, there is a problem in that the signal paths for the data signals must have uniform, good transmission properties over a very broad frequency range.

As a result, a clock-embedded conversion system is used in the present working example. A clock-embedded conversion system is a system for converting a pre-determined data string to a pre-determined pattern that includes 0 and 1 and transferring the data. As a result, it is possible to restore the original data even if clock signals are not transmitted together. There are no problems created by transmission delay time, even if the transmission speed increases. Moreover, the frequency of the data signals does not increase or decrease depends on the data pattern, and the transmission frequency zone can be kept within a constant range.

An example of the simplest clock-embedded conversion system is shown in FIG. 3(b). By means of this example, signals are converted by “10” (that is, from high to low) when the data value is 1 and by “01” (that is, from low to high), when the data value is 0. As is clear from FIG. 3(b), the data signals after conversion are always in the two states of a high level and a low level within one clock. Consequently, the data values can be restored on the receiving side, even if there are no clock signals. Moreover, it is clear that the frequency of the signals after conversion ranges from the full clock frequency to half the clock frequency.

The amount of information is doubled when simply by converting 1 bit data values to 2 bit data values, as shown in FIG. 3(b). Therefore, to increase the conversion efficiency, a conversion table that takes into consideration the incidence of data string units from 3 bits to 8 bits is used. A typical conversion method is called 8B/10B conversion method, as disclosed in JP Kokai [unexamined] 59[1984]-10,056. 8B/10B conversion is used for clock-embedded conversion by the measuring apparatus of the present working example. By means of 8B/10B conversion systems, 8 bit data is converted to a matching 10 bit data; as a result, the transmission efficiency drops by 20%. However, it becomes possible to represent the data that has a balanced number of 0 and 1, since there are 256 possible combinations with 8 bits and there are 1,024 possible combinations with 10 bits to match from. This conversion table for 8 bit data and 10 bit data is specified in 8B/10B conversion. Using 8 bit to 10 bit conversion, there are 1,024 possible combinations that can represent 8 bit data; therefore, the combinations that are not used to represent 8 bit data may be used for representing packet breaks or used for special purposes other than data. Several types of special characters are pre-defined in the conversion table. It is also possible to detect transmission errors by identifying reserved combinations that are not specified in the 8B/10B conversion table as illegal characters on the receiving side.

1. A measuring apparatus comprising:
a plurality of modules each having a parallel to serial converter;
a controller having a plurality of serial to parallel converters and at plurality of first-in first-out (FIFO) memories; and
serial buses connecting each of said modules and each of said parallel to serial converters.

2. The measuring apparatus according to claim 1, wherein said serial to parallel converters are clock-embedded serial to parallel converters.

3. The measuring apparatus according to claim 1, wherein said signals that are transmitted through said serial buses are differential signals.

4. The measuring apparatus according to claim 1, wherein said controller further comprises a processor, and a memory connected to said processor and said FIFO memories.

5. The measuring apparatus according to claim 1, wherein said modules each further comprise an additional serial to parallel converter and said controller comprises an additional parallel to serial converter.
